(19) United States
(12) Patent Application Publication
(10) Pub. No.: US 2010/0124532 A1
(43) Pub. Date: May 20, 2010

(54) Method For Preparing Copper Oxide Nano-Particles

(75) Inventors: Yi-Der Tai, Taipei City (TW); Ming-Hui Chang, Taipei City (TW); Chia-Te Tai, Taichung City (TW)

Correspondence Address: BEVER HOFFMAN & HARMS, LLP;901 Campisi Way, Suite 370, Campbell, CA, 95008, US

(73) Assignee: National Taiwan University, Taipei (TW)

(21) Appl. No.: 12/613,448

(22) Filed: Nov. 5, 2009

(30) Foreign Application Priority Data
Nov. 17, 2008 (TW) 097144425

(51) Int. Cl. C01G 3/02

(52) U.S. Cl. 423/604; 977/773

(57) ABSTRACT

A method for manufacturing the copper oxide nano-particles is provided. The method includes the steps of providing a copper-contained salt solution, providing a alkaline solution, mixing the copper-contained salt solution and the alkaline solution by using a high-gravity force provided by a high-gravity device to generate a slurry, removing the solvent in the slurry to obtain a precursor of the copper oxide nano-particles, and calcining the precursor to produce the copper oxide nano-particles.

### FIELD OF THE INVENTION

The present invention relates to a method for preparing copper oxide, especially to a method for preparing copper oxide nano-particles

### BACKGROUND OF THE INVENTION

The copper oxide is a dark brown powder, its use is quite widespread, including as the coloring agent for the glass and porcelain, the polishing compound for the optical glass, the catalyst for the organic synthesis and the catalyst for the rapid combustion of the rocket propulsion. In addition, the copper oxide also has good thermal conductivity, and lower price than noble metals, e.g. gold, silver, etc. Thus, the copper oxide is frequently used in the heat transfer fluid. The conventional heat transfer fluids include, for example, the working fluids used in the heat exchanger, the engine, the refrigeration and air-conditioning system. The biggest limitation in the application of the conventional heat transfer fluids results from its low thermal conductivity. In order to overcome this limitation, therefore the heat transfer fluids of new generation are developed. By dispersing the nano-particles of the metal or the metal oxide with excellent thermal conductivity into the working fluid, i.e. so-called nanofluid, the efficiency of the heat conduction can be largely enhanced. Here the nano-particles are the particles with the major dimension less than 100 nm. As an example the spherical particles, the main dimension is the diameter of the spherical particle. For an example of the non-spherical particles, the main dimension is the longest dimension of the particles. When the dimension of the particle is reduced, the ratio of its surface area to volume will increase. For example, when the particle size is reduced from 10 μm to 10 nm, the ratio of its surface area to volume will increase by 1000 times, indicating a thousand-fold surface area per unit volume for conducting heat. Therefore, compared with micron particles, the nano-particles will provide much better thermal conductive effect for the working fluids. Generally, the preparation methods of the nano-fluids can be divided into two methods, i.e. methods of the single step and the multi-steps. As to the method of the single step, it is disclosed in the U.S. Pat. No. 6,221,275B1 (2001) that the nano-particles are generated by the physical vaporization method under high temperature and high vacuum conditions inside the airtight reactor, and then directly introduced into the working fluid. The advantage of the single step method is that the nano-particles in the nano-fluid can be easily dispersed with less agglomeration. However its major drawback is that it is hard to control the compositions of the nano-particles, and the production rate is too slow. Thus, it is not suitable for mass production. In the multi-step method, the nano-particles are synthesized first, and then dispersed into the working fluid by using a specific dispersing method. Composition of the nano-particles can be accurately controlled by the synthesizing step. Besides, solid content of the nanofluid can be altered, and different type of nano-particles and working fluids can be matched up in various ways for different applications. Meanwhile, the multi-step method has the potential for mass production.

In the resent years, the researches and developments of the high-gravity system have solved a lot of issues that can not be solved in the gravity field. The high-gravity system can use rotating packed bed reactor and the spinning disk reactor. By using the rotating packed bed or spinning disk under high speed, the high-gravity force with hundred or even thousand times of the earth gravity is generated, and can disperse the liquid in the system into tiny droplets or thin liquid film so as to enhance the mass transfer rate and the mixing efficiency. The high-gravity system can be applied to the preparation of powders for facilitating the achievement of the powders with small sizes and narrow size distribution. In addition, the high-gravity system has the advantages of small dimensions, high production rate, and continuous operation, and hence it has the commercial potential. Currently, there is a method for preparing the nano-fluid by using rotating packed bed system. In this method, the liquids with different phases, e.g. water phase and organic phase, are contacted in the reactor of the rotating packed bed system, and the reaction occurs there. The mixed solution after the reaction can be phase-separated, and the nano-fluid containing metal oxide nano-particles dispersed in the organic phase can be directly obtained. However, the raw material in this method is the metal organic acid salt, which price is expensive and can not be easily acquired.

In order to solve the above mentioned problems, the new concepts and production methods are disclosed in the present invention, where the normal metal salts can be used as the raw materials, the copper oxide nano-particles can be mass-produced by continuous operation, the production cost can be largely reduced, and the produced copper oxide nano-particles have high quality of very small particle size and narrow size distribution.

### SUMMARY OF THE INVENTION

The present invention provides a method for preparing a copper oxide nano-particle by adopting the high-gravity system which has advantages of high mass transfer rate and high mixing efficiency. The copper oxide nano-particles of various specifications can be produced with continuous operation mode and high production rate.

In accordance with one aspect of the present invention, a method for preparing copper oxide nano-particles is provided. The method comprises providing a copper salt solution; providing an alkaline solution; and mixing the copper salt solution and the alkaline solution by using a high-gravity force provided by a high-gravity device to obtain a precursor of the copper oxide nano-particle.

Preferably, the step of mixing the copper salt solution and the alkaline solution forms a slurry having a solvent, and the method further comprises a step of removing the solvent of the slurry to obtain the precursor of the copper oxide nano-particle by a centrifuge.

Preferably, the copper salt solution comprises at least one selected from a group consisting of a copper sulfate, a copper nitrate, a copper chloride and a copper bromide, and the copper salt solution has a solvent being a water.

Preferably, the alkaline solution comprises at least one selected from a group consisting of a sodium carbonate, a potassium carbonate, a lithium carbonate and a sodium hydroxide, and the alkaline solution has a solvent being a water.

Preferably, the copper salt solution has a concentration in a range of 0.01M to 1M, and the alkaline solution has a concentration in a range of 0.01M to 1M.

Preferably, the high-gravity force provided by a high-gravity device is in a range of 2 g to 1000 g.

Preferably, the high-gravity force is preferably in a range of 200 g to 1000 g.

Preferably, the first three steps are performed under a room temperature.

Preferably, the precursor comprises Cu₂(OH)₂CO₃, and the high-gravity device comprises one of a rotating packed bed system and a spinning disk system.

Preferably, the method further comprises a step of calcining the precursor to obtain the copper oxide nano-particle.

Preferably, the step of calcining the precursor further comprises heating the precursor by gradually increasing a heating temperature to a calcining temperature higher than 300 degree C., and keeping the calcining temperature for a calcining period to obtain the copper oxide nano-particle.

In accordance with another aspect of the present invention, another method for preparing a copper oxide nano-particle is provided. The method comprises providing a precursor of the copper oxide nano-particle; and heating the precursor at a calcining temperature to obtain the copper oxide nano-particle.

Preferably, the step of heating the precursor is performed by gradually increasing a heating temperature up to a calcining temperature higher than 300 degree C., and keeping the calcining temperature for a calcining period.

Preferably, the calcining temperature is preferably one of higher than and equal to 500 degree C.

Preferably, the calcining period is longer than 5 minutes.

Preferably, the calcining period is preferably one of longer than and equal to 60 minutes.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is the schematic diagram showing the system for preparing the copper oxide nano-particles by using the high-gravity device in the present invention;

FIG. 2 is the schematic diagram showing the flowchart for preparing the copper oxide nano-particles in the present invention;

FIG. 3 is the schematic diagram showing the average particle sizes of the copper oxide nano-particles vs. the concentrations of the reactant solutions in the present invention; and

FIG. 4 is the schematic diagram showing the X-ray diffraction pattern of the copper oxide nano-particles produced in the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

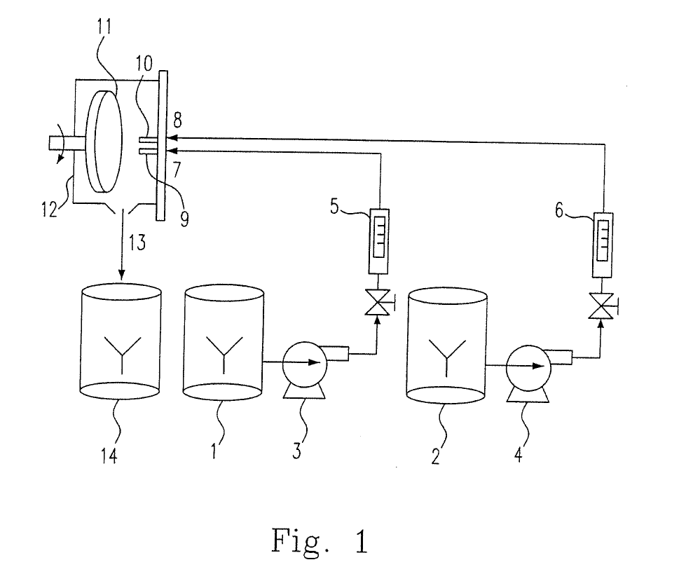

The system for preparing copper oxide nano-powders by using a high-gravity device is shown in FIG. 1. The specific embodiment of the present invention is illustrated by referring to FIG. 1 as follows. First, the copper salt solution and alkaline solution with the same concentration in the range between 0.01 to 1 M are prepared. Then the two solutions are poured into the storage tank 1 and tank 2, respectively. The solution of copper salts from the storage tank 1 is transported by using the liquid pump 3, and flows through the flow meter 5, inlet 7 and liquid distributor 9 to the center of the spinning disk 11, which is rotating around an axis. At the same time, the alkaline solution from the storage tank 2 is transported by using the liquid pump 4, and flows through the flow meter 6, inlet 8 and liquid distributor 10 to the center of the spinning disk 11, which is rotating. Two solutions are pumped into the spinning disk by the same flow rate in the range between 0.2 to 5 L/min. The spinning disk 11 with the diameter of 19.5 cm made of stainless steel is driven by the variable-speed motor and rotating in the plane perpendicular to the horizontal plane under high speed. The operational rotating speed can be chosen between 500 to 4000 rpm so as to produce the high-gravity field. The high-gravity force can be adjusted in the range between 2 g to 1000 g, preferably between 200 g to 1000 g.

The above copper salt solution can be selected from at least one of copper sulfate, copper nitrate, copper chloride, copper bromide solutions, or other copper-containing inorganic or organic solutions, the solvent of which can be water, other polar solvents, or mixed solvents consisting of water and other solvents. In this embodiment, the solvent is water. The above alkaline solution can be selected from at least one of sodium carbonate, potassium carbonate, lithium carbonate solutions, etc., the solvent of which can be water, other polar solvents, or mixed solvents consisting of water and other solvents. In t his embodiment, the solvent is water.

The above two solutions are spread on the disk under the high-gravity force to form a thin liquid film. The reaction occurs to generate the precursor of copper oxide, e.g. copper hydroxide carbonate (Cu₂(OH)₂CO₃), when the two solutions are mixed. The slurry containing precursor particles is thrown outwardly through the outer edge of the spinning disk 11, is stopped by the housing 12 of the reactor, and flows into the collection tank 14 along the inner wall of the housing 12 of the reactor through the outlet 13. The housing 12 of the reactor can be made of the plates of acrylic, aluminum, stainless steel or other materials. Subsequently, the slurry with the precursors is centrifuged for 10 minutes at the rotation speed of about 10,000 rpm. Then the liquid in the upper portion is removed and the precursor particles can be obtained. The chemical reaction to obtain the precursor of copper oxide, e.g. copper hydroxide carbonate (Cu₂(OH)₂CO₃), can be illustrated in the following chemical equation:

2CuSO₄+2Na₂CO₃+H₂O→Cu₂(OH)₂CO₃₍ₛ₎+2Na₂SO₄+CO₂

Then, the precursor particles are washed twice by using the mixture of the deionized water and acetone in a volume ratio of 1:1, and then washed once by using the acetone. The n, after drying, the dried precursor particles are placed inside the high-temperature furnace. The furnace temperature is increased from room temperature up to 100° C. (i.e. solvent boiling point) at the heating rate of 10° C./min, and then maintained for about 30 min to further remove residual moisture. After then, the furnace temperature is further increased to 500° C. (at least higher than 300° C.) at the previous heating rate, and then maintained for 60 min (at least 5 min or longer). Finally, the furnace temperature is cooled down to room temperature at the cooling rate of 10° C./min, and the product, i.e. the copper oxide nano-particles, can be taken out of the furnace. In addition, alternatively, the precursor particles after washing can be delivered into the high-temperature furnace, and the furnace temperature can be gradually increased to 500° C. at the heating rate of 10° C./min for calcining to obtain the copper oxide nano-particles. Of course, the above heating rate or cooling rate can be appropriately adjusted depending on the quantity of the precursor particles and the practical requirements of the mass production.

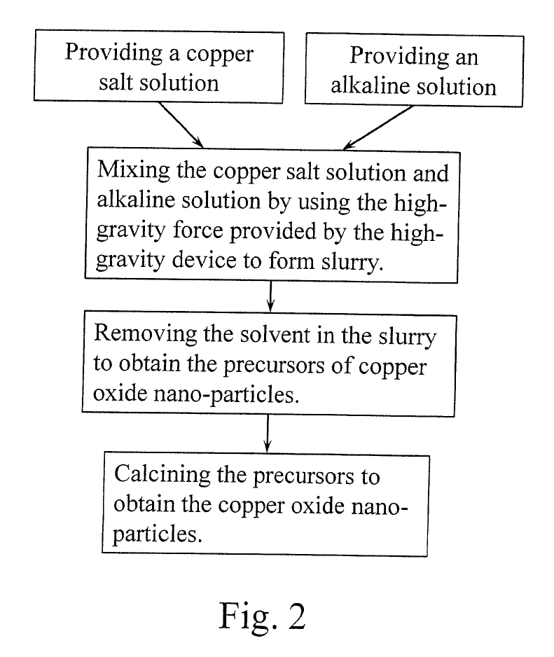

To sum up, this invention provides methods for preparing the copper oxide nano-particles, and the methods can be summarized into the major steps as shown in the flowchart of FIG. 2. Please refer to FIG. 2. Firstly, the copper salt solution and alkaline solution are provided. Secondly, the copper salt solution and alkaline solution are mixed by using the high-gravity force provided by the high-gravity device to form slurry. In the following, the solvent in the slurry is removed in order to obtain the precursors of the copper oxide nano-particles. Finally, the precursors are calcined to obtain the copper oxide nano-particles. The chemical reaction by calcining the copper oxide precursor, e.g. copper hydroxide carbonate (Cu₂(OH)₂CO₃), to obtain the copper oxide can be illustrated in the following chemical equation:

Cu₂(OH)₂CO₃₍ₛ₎→2CuO₍ₛ₎+CO₂+H₂O

In the present invention, the copper oxide nano-particles in several desired particle sizes can be produced by changing the operation variables, including the concentrations of the reactant solutions, flow rate of the reactant solution, rotation speed of the spinning disk, etc. The results are described as follows.

According to the concept of the present invention, the above mentioned spinning disk can be substituted by the rotating packed bed or any other device, which can provide the high-gravity force.

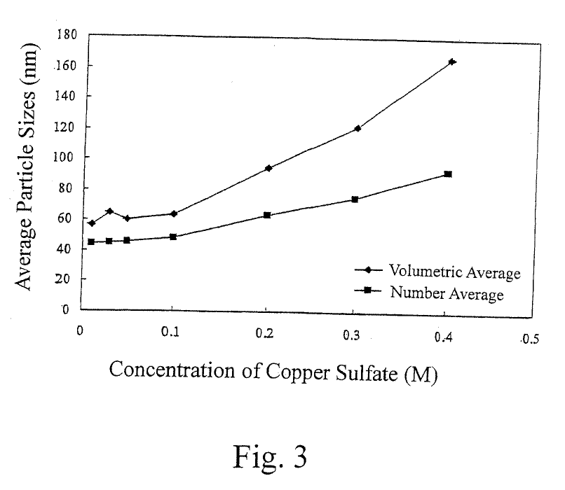

The effect of the concentrations of the reactant solutions: when investigating the effect of the concentrations of the reactant solutions, the highest rotation speed of the spinning disk is fixed at 4000 rpm, the flow rate is adjusted at 0.2 L/min at minimum, and the concentrations of the reactant solutions are changed from 0.01 to 0.4 M. There is not much difference in the yield of the resulted copper oxides, and all yield rates are higher than 90%. The volumetric average and number average of particle sizes vs. the concentrations of the reactant solutions is shown in FIG. 3. It is known from FIG. 3 that the volumetric average particle sizes remain between 60 and 70 nm when the concentrations of the reactant solutions are below 0.1 M. However, when the concentrations of the reactant solutions are raised to 0.4 M, the volumetric average particle size increases to about 170 nm, while the number average particle sizes falls between 40 and 80 nm in the concentration range investigated.

In addition, if other operation variable, e.g. flow rate of the reactant solution or the rotation speed, is changed, the nano-particles with the average particle size in the range of 20 to 200 nm can be obtained, depending on the operation variables.

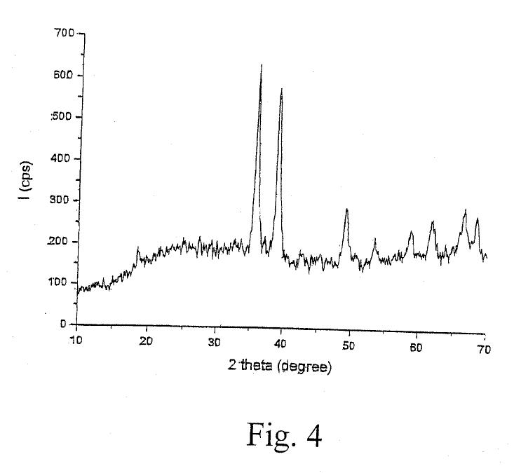

The X-ray diffraction patterns of the copper oxide nano-particles prepared in the present invention are shown in FIG. 4. The copper oxide nano-particles prepared in the present invention have quasi-spherical shapes. In addition, after comparing the X-ray diffraction patterns of the obtained copper oxide nano-particles in the present invention with those of the standard samples, it is confirmed that the obtained copper oxide nano-particles have the monoclinic crystal structure.

To sum up, the present invention provides novel methods for preparing the copper oxide nano-particles. The copper oxide nano-powders can be mass-produced with continuous operation mode. The production cost can be significantly reduced. The produced copper oxide nano-particles have high qualities of very small particle sizes and narrow size distribution. Furthermore, the particle sizes of the copper oxide nano-particles can be tuned by adjusting the concentrations of the reactant solutions, the flow rates of the reactant solutions and the rotating speed of the spinning disk.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for preparing a copper oxide nano-particle, comprising:
providing a copper salt solution;
providing an alkaline solution; and
mixing the copper salt solution and the alkaline solution by using a high-gravity force provided by a high-gravity device to obtain a precursor of the copper oxide nano-particle.

2. A method according to claim 1, wherein the step of mixing the copper salt solution and the alkaline solution forms a slurry having a solvent, and the method further comprises a step of removing the solvent of the slurry to obtain the precursor of the copper oxide nano-particle by using a centrifuge.

3. A method according to claim 1, wherein the copper salt solution comprises at least one selected from a group consisting of a copper sulfate, a copper nitrate, a copper chloride and a copper bromide, and the copper salt solution has a solvent being a water.

4. A method according to claim 1, wherein the alkaline solution comprises at least one selected from a group consisting of a sodium carbonate, a potassium carbonate, a lithium carbonate and a sodium hydroxide, and the alkaline solution has a solvent being a water.

5. A method according to claim 1, wherein the copper salt solution has a concentration in a range of 0.01M to 1M, and the alkaline solution has a concentration in a range of 0.01M to 1M.

6. A method according to claim 1, wherein the high-gravity force provided by the high-gravity device is in a range of 2 g to 1000 g.

7. A method according to claim 6, wherein the high-gravity force is preferably in a range of 200 g to 1000 g.

8. A method according to claim 1, wherein the first three steps are performed under a room temperature.

9. A method according to claim 1, wherein the precursor comprises Cu₂(OH)₂CO₃, and the high-gravity device comprises one of a rotating packed bed system and a spinning disk system.

10. A method according to claim 1, further comprising a step of calcining the precursor to obtain the copper oxide nano-particle.

11. A method according to claim 10, wherein the step of calcining the precursor further comprises heating the precursor by gradually increasing a heating temperature to a calcining temperature higher than 300 degree C., and keeping the calcining temperature for a calcining period to obtain the copper oxide nano-particle.

12. A method according to claim 11, wherein the calcining temperature is preferably one of higher than and equal to 500 degree C.

13. A method according to claim 11, wherein the calcining period is longer than 5 minutes.

14. A method according to claim 13, wherein the calcining period is preferably one of longer than and equal to 60 minutes.

15. A method for preparing a copper oxide nano-particle, comprising:
providing a precursor of the copper oxide nano-particle; and
heating the precursor at a calcining temperature to obtain the copper oxide nano-particle.

16. A method according to claim 15, wherein the precursor comprises Cu₂(OH)₂CO₃.

17. A method according to claim 15, wherein the step of heating the precursor is performed by gradually increasing a heating temperature up to a calcining temperature higher than 300 degree C., and keeping the calcining temperature for a calcining period.

18. A method according to claim 17, wherein the calcining temperature is preferably one of higher than and equal to 500 degree C.

19. A method according to claim 17, wherein the calcining period is longer than 5 minutes.

20. A method according to claim 19, wherein the calcining period is preferably one of longer than and equal to 60 minutes.
